(19) United States
(12) Patent Application Publication
(10) Pub. No.: US 2020/0095969 A1
(43) Pub. Date: Mar. 26, 2020

(54) REMOTE START OF A MOTOR VEHICLE

(71) Applicant: GM Global Technology Operations LLC, Detroit, MI (US)

(72) Inventors: Shanmukh A. Rajurs, Northville, MI (US); Daniel C. McGarry, Shelby Township, MI (US)

(21) Appl. No.: 16/142,936

(22) Filed: Sep. 26, 2018

(51) Int. Cl. F02N 11/08; H04W 4/20

(52) U.S. Cl. CPC F02N 11/0807; H04W 4/40; F02N 2300/304; H04W 4/20

(57) ABSTRACT

A method for remote starting a motor vehicle includes collecting cabin temperature over a period of time during a remote start of the motor vehicle, developing a temperature vs. time profile for the motor vehicle based on the collection of the cabin temperature over the period of time in a back office, and notifying a user of the motor vehicle when to initiate subsequent remote starts to obtain a desired cabin temperature of the motor vehicle.

### INTRODUCTION

The present disclosure relates to remote starting a motor vehicle.

In many motor vehicles today, a user of a motor vehicle, such as the driver, is able to activate an application on a mobile device, such as a smartphone, to start the motor vehicle from a remote location. The instructions from the mobile device are transmitted to a cloud back office, which in turn transmits signals to the motor vehicle to start. After starting, the motor vehicle operates for a period of time, for example, ten to fifteen minutes. The user may send another request to start the vehicle if the user is does not enter the vehicle during the initial remote start sequence.

After one or more remote start instructions have been sent to the motor vehicle, warm or cool air is blown into the cabin to obtain a cabin temperature that was set during the previous operation of the motor vehicle.

Thus, while current remote start operations achieve their intended purpose, there is a need for a new and improved system and method for remote starting a motor vehicle.

### SUMMARY

According to several aspects, a method for remote starting a motor vehicle includes collecting cabin temperature over a period of time during a remote start of the motor vehicle, developing a temperature vs. time profile for the motor vehicle based on the collection of the cabin temperature over the period of time in a back office, and notifying a user of the motor vehicle when to initiate subsequent remote starts to obtain a desired cabin temperature of the motor vehicle.

In an additional aspect of the present disclosure, the method further includes collecting cabin temperature over a period of time during subsequent remote starts of the motor vehicle.

In another aspect of the present disclosure, developing includes developing the temperature vs. time profile based on the subsequent collection cabin temperature over periods of time.

In another aspect of the present disclosure, notifying includes notifying the user to remote start the motor vehicle prior a departure time to obtain the desired cabin temperature at the departure time.

In another aspect of the present disclosure, the method further includes collecting and developing cabin temperature vs. time profiles of one or more other motor vehicles in the vicinity of the user's motor vehicle.

In another aspect of the present disclosure, developing a cabin temperature vs. time profile of the user's motor vehicle includes averaging cabin temperature vs. time profiles of the one or more other motor vehicles in the vicinity of the user's motor vehicle.

In another aspect of the present disclosure, the vicinity of the user's motor vehicle is within a predefined range of the user's motor vehicle.

In another aspect of the present disclosure, remote starting of the motor vehicle is initiated with a mobile device that communicates with the back office.

According to several aspects, a method for notifying a user of a motor vehicle when to remote start the motor vehicle includes collecting and developing cabin temperature vs. time during remote starts of the user's motor vehicle in a back office, collecting and developing cabin temperature vs. time profiles of one or more other motor vehicles in the vicinity of the user's motor vehicle in the back office, and notifying the user of the motor vehicle when to initiate remote starts to obtain a desired cabin temperature of the motor vehicle based on the temperature vs. time profile of the user's motor vehicle and initial cabin temperatures of the other motor vehicles in the vicinity of the motor vehicles when remote starts are initiated of the motor vehicles in the vicinity of the user's motor vehicle.

In another aspect of the present disclosure, notifying includes notifying the user to remote start the motor vehicle prior to a departure time to obtain the desired cabin temperature at the departure time.

In another aspect of the present disclosure, developing cabin temperature vs. time profile of the user's motor vehicle includes averaging cabin temperature vs. time profiles of the one or more motor vehicles of the same type as the user's motor vehicle in the vicinity of the user's motor vehicle.

In another aspect of the present disclosure, the vicinity of the user's motor vehicle is within a predefined range of the user's motor vehicle.

In another aspect of the present disclosure, remote starting of the motor vehicle is initiated with a mobile device that communicates with the back office.

According to several aspects, a method to remote start a motor vehicle includes collecting cabin temperature over a period of time during multiple remote starts of the motor vehicle, developing a temperature vs. time profile for the motor vehicle based on the collection of the cabin temperature over the period of time for the multiple starts in a back office, and notifying a user of the motor vehicle when to initiate remote starts to obtain a desired cabin temperature of the motor vehicle.

In another aspect of the present disclosure, notifying includes notifying the user to remote start the motor vehicle prior to a departure time to obtain the desired cabin temperature at the departure time.

In another aspect of the present disclosure, the method further includes collecting and developing cabin temperature vs. time profiles of one or more other motor vehicles of the same type as the user's motor vehicle.

In another aspect of the present disclosure, developing a cabin temperature vs. time profile of the user's motor vehicle includes averaging cabin temperature vs. time profiles of the one or more motor vehicles of the same type as the user's motor vehicle.

In another aspect of the present disclosure, the vicinity of the user's motor vehicle is within a pre-defined range of the user's motor vehicle.

In another aspect of the present disclosure, remote starting of the motor vehicle is initiated with a mobile device that communicates with the back office.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is an overview of as system for remote starting a motor vehicle according to an exemplary embodiment; and

FIG. 2 is a flow diagram of a process for remote starting a motor vehicle according to an exemplary embodiment.

### DETAILED DESCRIPTION

The following description is merely exemplary in nature and is not intended to limit the present disclosure, application, or uses.

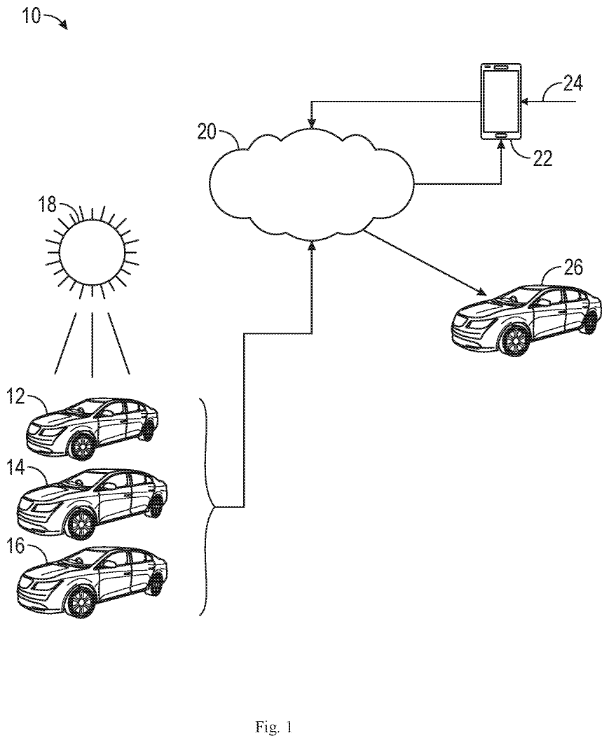

Referring to FIG. 1, there is shown a system 10 to remote start a motor vehicle 26 in accordance with the principles of the present disclosure. In one arrangement, a back office, such as, for example, a cloud database 20 collects the cabin temperature of the motor vehicle 26 over a period of time after the motor vehicle receives instructions from the cloud 20 to remote start. In a various arrangement, a user of the motor vehicle 26, such as a driver, inputs instructions 24 into any suitable application or device to remote start the motor vehicle 26. For example, the user inputs instructions 24 into a web application or a voice service device, such as, the mobile device 22 in particular arrangements to remote start the motor vehicle 26. These instructions are relayed to the cloud 20, which, in turn, instructs the motor vehicle 26 to start.

After the motor vehicle has started, the back office in the cloud 20 develops a temperature vs. time profile from the collected data for the motor vehicle 26. In various arrangements, the back office in the cloud 20 collects data for multiple remote starts to develop temperature vs. time profiles for the motor vehicle 26. As such, profiles are developed for situations when the motor vehicle 26 is being heated, for example, by the sun 18 and is to be cooled to a desired temperature set by the user, while other profiles are developed for situations when the cabin is to be heated to a desired temperature. Based on these profiles, the back office in the cloud 20 notifies the user, for example, through the mobile device 22, when to initiate subsequent remote starts to obtain a desired cabin temperature for the motor vehicle 26 in various ambient conditions. In particular arrangements, the back office in the cloud 20 is aware of a usual departure time of the user by integrating the user's calendar or a scheduling function on, for example, the mobile device 22. As such, the back office in the cloud 20 notifies the user to remote start the motor vehicle 26 prior to the departure time to obtain the desired cabin temperature at the departure time.

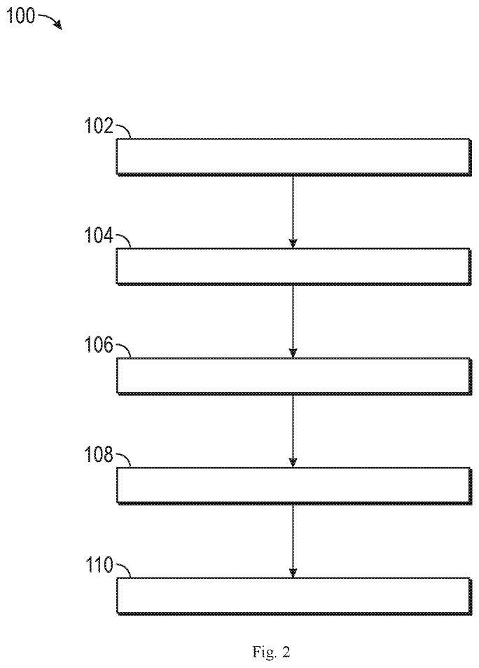

In various arrangements, the system 10 collects and develops cabin temperature vs. time profiles of one or more other motor vehicles of the same type of vehicle 12, 14, 16 of the motor vehicle 26 in the vicinity, for example, within about 30 miles, of the motor vehicle 26, as shown as a process 100 in FIG. 2. Specifically, remote start requests for the vehicles 12, 14, 16 are initiated in a step 102. In step 104, the back office in the cloud 20 collects this data and develops various temperature vs. time profiles of the vehicles 12, 14, 16. In particular arrangements, the profiles of the other vehicles 12, 14, 16 are averaged. The temperature vs. time profiles of the motor vehicle 26 then implements these averaged profiles to provide updated temperature vs. time profiles for the motor vehicle 26. The temperature vs. time profile of the motor vehicle 26 adjusts based on the specific performance of the motor vehicle 26.

Based on these profiles, and the initial cabin temperatures of the vehicles 12, 14, 16 in the vicinity of the motor vehicle 26, the back office in the cloud 20 notifies the user in a step 106, for example, through the mobile device 22, when to initiate a remote start to obtain a desired cabin temperature for the motor vehicle 26 in various ambient conditions. In particular arrangements, the back office in the cloud 20 is aware of a usual departure time of the user. As such, the back office in the cloud 20 notifies the user to remote start the motor vehicle 26 prior to the departure time to obtain the desired cabin temperature at the departure time. In a step 108, the user through the mobile device 22 sends instructions 24 through the cloud 20 when to remote start the motor vehicle 26 prior to a desired or pre-determined departure time. In a step 110, the process 100 collects the user's vehicle specific data for the motor vehicle 26 to model the temperature vs. time performance for that specific vehicle.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method for remote starting a motor vehicle, the method comprising:
collecting cabin temperature over a period of time during a remote start of the motor vehicle;
developing a temperature vs. time profile for the motor vehicle based on the collection of the cabin temperature over the period of time in a back office; and
notifying a user of the motor vehicle when to initiate subsequent remote starts to obtain a desired cabin temperature of the motor vehicle.

2. The method of claim 1 further comprising collecting cabin temperature over a period of time during subsequent remote starts of the motor vehicle.

3. The method of claim 2 wherein developing includes developing the temperature vs. time profile based on the subsequent collection cabin temperature over periods of time.

4. The method of claim 1 wherein notifying includes notifying the user to remote start the motor vehicle prior a departure time to obtain the desired cabin temperature at the departure time.

5. The method of claim 1 further comprising collecting and developing cabin temperature vs. time profiles of one or more other motor vehicles in the vicinity of the user's motor vehicle.

6. The method of claim 5 wherein developing a cabin temperature vs. time profile of the user's motor vehicle includes averaging cabin temperature vs. time profiles of the one or more other motor vehicles in the vicinity of the user's motor vehicle.

7. The method of claim 5 wherein the vicinity of the user's motor vehicle is within a predefined range of the user's motor vehicle.

8. The method of claim 1 wherein remote starting of the motor vehicle is initiated with a mobile device that communicates with the back office.

9. A method for notifying a user of a motor vehicle when to remote start the motor vehicle, the method comprising:
collecting and developing cabin temperature vs. time during remote starts of the user's motor vehicle in a back office;
collecting and developing cabin temperature vs. time profiles of one or more other motor vehicles in the vicinity of the user's motor vehicle in the back office; and
notifying the user of the motor vehicle when to initiate remote starts to obtain a desired cabin temperature of the motor vehicle based on the temperature vs. time profile of the user's motor vehicle and initial cabin temperatures of the other motor vehicles in the vicinity of the motor vehicles when remote starts are initiated of the motor vehicles in the vicinity of the user's motor vehicle.

10. The method of claim 9 wherein notifying includes notifying the user to remote start the motor vehicle prior to a departure time to obtain the desired cabin temperature at the departure time.

11. The method of claim 9 wherein developing cabin temperature vs. time profile of the user's motor vehicle includes averaging cabin temperature vs. time profiles of the one or more motor vehicles of the same type as the user's motor vehicle in the vicinity of the user's motor vehicle.

12. The method of claim 9 wherein the vicinity of the user's motor vehicle is within a predefined range of the user's motor vehicle.

13. The method of claim 1 wherein remote starting of the motor vehicle is initiated with a mobile device that communicates with the back office.

14. A method to remote start a motor vehicle, the method comprising:
collecting cabin temperature over a period of time during multiple remote starts of the motor vehicle;
developing a temperature vs. time profile for the motor vehicle based on the collection of the cabin temperature over the period of time for the multiple starts in a back office; and
notifying a user of the motor vehicle when to initiate remote starts to obtain a desired cabin temperature of the motor vehicle.

15. The method of claim 14 wherein notifying includes notifying the user to remote start the motor vehicle prior to a departure time to obtain the desired cabin temperature at the departure time.

16. The method of claim 14 further comprising collecting and developing cabin temperature vs. time profiles of one or more other motor vehicles of the same type as the user's motor vehicle.

17. The method of claim 16 wherein developing a cabin temperature vs. time profile of the user's motor vehicle includes averaging cabin temperature vs. time profiles of the one or more motor vehicles of the same type as the user's motor vehicle.

18. The method of claim 17 wherein the vicinity of the user's motor vehicle is within a pre-defined range of the user's motor vehicle.

19. The method of claim 14 wherein remote starting of the motor vehicle is initiated with a mobile device that communicates with the back office.
